(19) United States
(12) Patent Application Publication
(10) Pub. No.: US 2020/0022334 A1
(43) Pub. Date: Jan. 23, 2020

(54) HOOF COVER

(71) Applicant: SANCTUARY HEALTH SDN. BHD., Ipoh, Perak (MY)

(72) Inventor: Chaur Long CHANG, Ipoh, Perak (MY)

(21) Appl. No.: 16/312,745

(22) PCT Filed: Sep. 26, 2016
(86) PCT No.: PCT/MY2016/000067

§ 371 Date: Jul. 16, 2019

(30) Foreign Application Priority Data
Jun. 24, 2016 (MY) PI 2016702339

(51) Int. Cl. A01K 13/00

(52) U.S. Cl. CPC A01K 13/007

(57) ABSTRACT

The present invention provides a hoof cover that is elastic and stretchable over the hoof of animals such as ruminants and equines. The hoof cover is suitable to be used for the treatment of hoof diseases wherein the cover will securely hold a dressing or a treatment pad. The hoof cover comprises an opening for foot insertion (205) and openings (201, 203) for at least partially exposing the hoof.

### TECHNICAL FIELD OF INVENTION

This invention relates generally to a foot cover for hoofed animals such as ruminants and equines.

### BACKGROUND OF THE INVENTION

The present invention provides a hoof cover that is elastic and stretchable over the hoof of animals such as ruminants and equines to securely hold a dressing or treatment pad over the infected area of the hoof. The hoof cover of the present invention is suitable to be used for the treatment of hoof diseases such as digital dermatitis.

To treat the hoof, some users may apply a dressing to the hoof and use plastic films or cloths to bandage the hoof. Some users may also use plastic bags to cover the hoof with a collar or the opening of the bag being tied to leg with additional fastener such as a rope or a Velcro fastener. These methods provide a loose attachment to the leg and may not be ideal due to leg movements of the animals.

The US patent publication no. 2014/0196915 discloses a hoof cover. The cover includes a hoof shoe and a sock joined at a seam. The U.S. Pat. No. 7,818,952 discloses a hoof boot comprises an elastic, hoof-enveloping casing. Hoof covers that are formed to be like a shoe or a boot as disclosed in the above documents, are not desirable as these types of hoof covers require a sole that will increase the length of the leg. Further, the construction of the shoe or the boot will require more materials rendering it more expensive to manufacture than the hoof cover of the present invention.

The EP patent no. EP1309255 discloses an elastic hoof cover wherein the cover may be moulded with stretchable compound such as latex and the process of making disposable examination gloves may be adopted.

Typically, in the making of latex gloves, different sizes of moulds are used to produce gloves with different sizes. The moulds are dipped into a latex solution and the latex is cured to take the shape and size of the moulds. In the final process, the cured gloves will be stripped from the moulds. This method produces gloves without a seam.

It has been observed that cured latex on a mould that has a hoof shape is difficult to be stripped off due to the shape and oversized section of the hoof.

In view of the above shortcomings, it is an object of the present invention to provide a hoof cover that is elastic and stretchable to securely hold an item such as a dressing or a treatment pad that can be provided without the need of being moulded.

It is another object of the present invention to provide a method for making a hoof cover that is elastic and stretchable from a sheet of an elastic material without the need of being moulded or undergone the typical moulding process.

### SUMMARY OF THE INVENTION

According to the present invention, a hoof cover for hoofed animals such as ruminants and equines comprising an elastically stretchable body with an opening for foot-insertion, an opening for at least partially exposing the hoof and another opening for at least partially exposing the hoof wherein first and second sides of the body are seamed with a cloth or fabric.

The blank in this invention refers to an article with a shape or form that is ready to be used or processed. Preferably, the blank of the present invention is a cut-out of an elastic sheet. Preferably, the elastic sheet is composed of latex or like compound. A die-cutting process will be used to obtain the preferred shape of the blank.

Preferably, the blank comprises a first wing on one side and a second wing on the other side. The wings extend from a vertical axis of the blank wherein on the axis an upper notch and a lower notch are located. The notch is formed by a curved cut. To form the hoof cover of this invention, the blank are folded about the vertical axis to place the first wing to face the second wing wherein the individual curved cut sections will be folded into half. In this folding position, the first and second sides of the wings are stitched together with a cloth wherein the stitching defines the foot-insertion opening and the opening at the corners of the hoof cover. The stitching of the elastic material to the cloth provides a secure attachment of the cover and prevents the cover from breaking when it is stretched over the hoof or leg of animals.

In an embodiment, a cloth is placed between the wings that are facing to each other in the folding position and stitched together to seam or join the respective sides of the hoof cover. In another embodiment, a cloth is placed between the wings that are facing to each other in the folding position and an additional cloth is placed onto the wings and stitched together to cover and join the respective sides of the hoof cover.

### BRIEF DESCRIPTION OF THE DRAWINGS

The present invention will be described by the way of example in reference to the accompanying drawings, in which:

FIG. 1 shows a blank of an elastic material for making a hoof cover according to an embodiment of the present invention;

FIG. 2 shows a hoof cover made from the blank shown in FIG. 1; and

FIG. 3 shows a hoof cover shown in FIG. 2 with an additional cloth stitched at its sides.

### DETAILED DESCRIPTION OF THE INVENTION

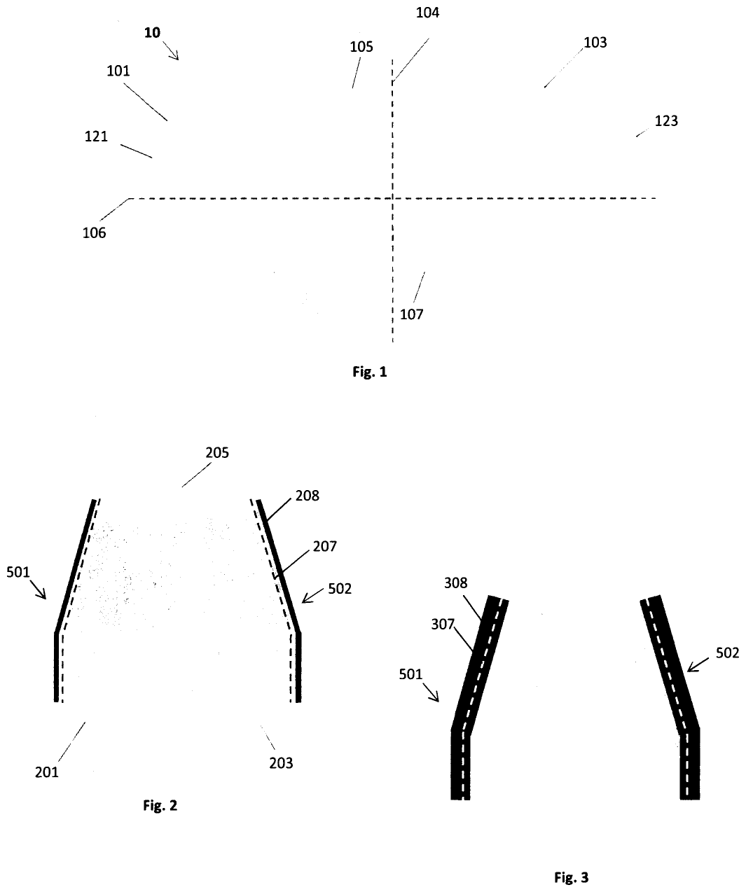

Referring to FIG. 1, an example of blank of an elastic sheet is provided for making a hoof cover according to the present invention. Preferably, the elastic sheet is composed of latex or like compound that will provide the stretchability over the hoof Preferably, the blank (10) has a wing (101) on one side and another wing (103) on the other side wherein each wing extends from a vertical axis (104) of the blank. On the vertical axis (104), an upper notch (105) with a curved cut is located at one end and a lower notch (107) with a curved cut is located at the other end. The curve cut of the notch is defined by one or more radiuses. The blank in FIG. 1 shows that the outer section of the wing includes a trapezoid that is followed by a rectangular wherein a corner section on one side of the rectangle is being cut away to form the said notches. The trapezoid forms slanting profiles that are connected to the flat profiles of the rectangle. The combination of these profiles defines the first (501) and second (502) sides that are to be stitched or defines the seaming area of the sheet. Depending on the geometrical shape of the wing, the said first and second sides can also have a curved profile for example, from end to end of the wing.

For example, the span of the blank is in the range of 30 cm to 32 cm and the thickness of the sheet is in the range of 0.22 mm to 0.30 mm. The outer vertical side (121, 123) of the first wing and second wing is in the range of 10 cm to 11 cm. The intermediate vertical length of the blank on the vertical axis (104) is preferably in the range of 50 mm to 70 mm. These dimensions may vary in order to provide hoof covers with different sizes.

FIG. 2 shows a front view of a hoof cover made from the blank shown in FIG. 1. To form the hoof cover, the blank are folded about the vertical axis (104). In this folding position the wings are facing to each other wherein the individual notches (105,107) will be folded into half In this folding position, the first side and second side of both wings are stitched together with a cloth (208). Preferably, the cloth is placed between the wings to secure the sheet wherein the stitching (207) on the first (501) and second (502) sides of the wings defines the opening (205) for the insertion of the foot of hoofed animals, the openings (201, 203) for at least partially exposing the hoof.

FIG. 3 shows the hoof cover of FIG. 2 having the first (501) and second sides (502) of the wings stitched (307) together with a cloth in between and an additional cloth (308) over the wings.

The process of making the hoof cover according to the present invention begins with compounding raw latex with chemical and colour mixing. Next, the latex compound is dipped and cured to produce a sheet. Then, the sheet is cut into a preferred shape or blank by a die-cutting machine. The blank needs to be washed to remove any powder before it can be stitched together with a cloth to form a complete hoof cover. The stitching parameter includes a thread size of around 0.22 mm with a pitching of preferably 9 stitches per inch with a needle size of around 110/18.

1. A hoof cover for hoofed animals comprising an elastically stretchable body with a foot-insertion opening (205), an opening (201) for at least partially exposing the hoof and another opening (203) for at least partially exposing the hoof wherein the body is formed from a blank (10) of an elastic sheet that is seamed with a cloth (208).

2. A hoof cover as claimed in claim 1 wherein the blank is a cut-out of an elastic sheet that is composed of latex.

3. A hoof cover as claimed in claim 1 wherein the blank comprises a wing (101) on one side and another wing (103) on the other side.

4. A hoof cover as claimed in claim 1 wherein the opening (201) for at least partially exposing the hoof is formed by a notch (105) with a curved cut located at one end on a vertical axis (104) of the blank.

5. A hoof cover as claimed in claim 1 wherein the other opening (203) for at least partially exposing the hoof is formed by a notch (107) with a curved cut located at the other end on a vertical axis (104) of the blank.

6. A hoof cover as claimed in claims 1 and 3 wherein the sheet or blank is folded about its vertical axis (104) to place the wings to face to each other and the cloth (208) is placed between the wings and stitched together to seam a first side (501) and a second side (502) of sheet.

7. A hoof cover as claimed in claims 1 and 3 wherein the sheet is folded about its vertical axis (104) to place the wings to face to each other and the cloth (208) is placed between the wings, and another cloth (308) is placed over the wings and stitched together to seam a first side (501) and a second side (502) of sheet.

8. A blank (10) for a hoof cover comprising a wing (101) on one side and another wing (103) on the other side wherein each wing extends from a vertical axis (104) of the blank.

9. A blank for a hoof cover as claimed in claim 8 further comprising an upper notch with a curved cut located at one end of the vertical axis and a lower notch with a curved cut located at the other end of the vertical axis.

10. A blank as claimed in claim 8 wherein the blank is a cut-out of an elastic sheet that is composed of latex.

11. A blank as claimed in claim 7 wherein the blank comprises a span in the range of 30 cm to 32 cm, an outer vertical side in the range of 10 cm to 11 cm, and an intermediate vertical length on vertical axis (104) in the range of 50 mm to 70 mm.

12. A blank as claimed in claim 7 wherein the blank has a thickness in the range the range of 0.22 mm to 0.30 mm.
